(19) United States
(12) Patent Application Publication
(10) Pub. No.: US 2007/0048088 A1
(43) Pub. Date: Mar. 1, 2007

(54) Method and assembly for withdrawing or supplying substances from/to a soil body

(75) Inventors: Dirk Albertus Bodegom, Bergambacht (NL); Robertus Cornelis Jacobus Maria Rullens, Made (NL); Arie Hessel Nooy Van Der Kolff, Den Haag (NL)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(73) Assignee: Baggermaatschappij Boskalis B.V.

(21) Appl. No.: 10/558,590

(22) PCT Filed: May 27, 2004
(86) PCT No.: PCT/NL04/00378

§ 371 Date: Aug. 21, 2006

(30) Foreign Application Priority Data
May 28, 2003 (NL) 1023555

(51) Int. Cl. B09B 1/00

(52) U.S. Cl. 405/129.85

(57) ABSTRACT

Method for withdrawing or introducing substances from or into a soil body, wherein a series of passage elements (6) that are vertical or at an angle, are introduced into the soil body, which passage elements are fluid intaking or fluid discharging over a substantial part of their length, wherein the vertical passage elements each at their top end are connected to their own suction line or pressure line for fluid (7), and the—preferably flexible—suction lines or pressure lines are connected to a pump (11), which pump is connected to a discharge or source for the fluid, after which by operation of the pump fluid is withdrawn from or supplied to the soil body, via the suction line or pressure line and the vertical passage elements.

The invention relates to a method and assembly for withdrawing or supplying substances, in solid, liquid or gaseous condition, from or to a soil body. A soil body here means a body situated in a soil, such as a layer or package, comprising soil (for instance clay or peat) and/or a quantity of material put in, such as a dump or depot. The soil body may be included in a water bed. The soil body may reach the ground level or water bed surface.

It is known to withdraw water from a soft soil layer or soil stratum, such as a clay-containing or peat-containing soil layer, in order to consolidate it using an arrangement of vertical drainage elements, such as drainage ribbons, introduced into said layer. Said drainage ribbons have been introduced from the bottom of a trench and are connected there with their top ends to a horizontal drainage pipe placed in the trench (that was closed again afterwards), which drainage pipe is connected to a suction pump. An example of such an arrangement has been described in applicant's International patent application PCT/NL01/00726. By means of a device provided with a plough, a drainage ribbon supplier and a drainage pipe supplier, a part of the trench is made step-wise, a drainage ribbon is pressed into the soil and cut off, and subsequently a next part of the trench is made while supplying a corresponding length of drainage pipe. The drainage pipe is covered substantially airtight by soil originating from the trench walls. The trench is then closed.

Said technique proved to be efficient and effective. However there are areas in which elements that may be soil-alien, are present, such as old pipes or cables, rubble, rails, scrap or the like. Trunks or roots of trees removed long ago may also still be present. Said elements may render the making of the trench considerably difficult.

Therefore there is a need for a method and arrangement for consolidating a soil layer or soil stratum which is not or less hampered by the aforementioned alien elements.

Furthermore there is a need for a simple and easily deployable method and arrangement for withdrawing substances, in gaseous, solid or liquid state, from a soil layer.

There is furthermore a need for a simple and easily deployable method and arrangement for supplying substances to a soil layer.

Furthermore there is a need for a system that can be used under water for accelerating the consolidation of sea bed surfaces, river bed surfaces and channel beds.

It is an object of the invention to supply at least one of these needs.

From one aspect the invention to that end provides a method for withdrawing or introducing substances from or into a soil body, wherein a series of passage elements that are placed vertically or at an angle, are introduced into the soil body, which passage elements are fluid intaking or fluid discharging over a substantial part of their length, wherein the vertical passage elements each at their top end are connected to their own suction line or pressure line for fluid, and the suction lines or pressure lines are connected to a pump, which pump is connected to a discharge or source for the fluid, after which by operation of the pump fluid is withdrawn from or supplied to the soil body, via the suction line or pressure line and the vertical passage elements.

Due to the use of separate suction lines or pressure lines from the passage elements there is greater freedom in the choice of the mutual position of the passage elements, yet they can indeed be connected to the same pump and therefore be operational in the same regime.

This freedom is increased when flexible suction lines or pressure lines are used. The movements in the soil body or above it can then also be followed without problems.

The suction lines or pressure lines can each be separately connected to the pump, optionally with interposition of a collection tray connected to the pump. In case of many and/or long pressure lines or suction lines the arrangement can be simplified by connecting these lines to one or more collection lines that connect to the pump.

When the collection line is flexible the freedom of installation is further increased and thus the movements in the soil body or another body that supports the collection line can also be followed.

Preferably the passage elements are flexible, as a result of which the settlements in the soil body can be followed without problems.

Preferably the passage elements are connected to their accompanying suction line by means of a coupling which is situated in the soil body. After introduction into the soil body, the passage elements can then be connected in series to the further lines in a separate operational action. Furthermore a separation can thus be arranged in the line from the end up to the pump, wherein only the passage elements are permeable. Preferably the coupling is watertight and/or gastight.

In a possible arrangement passage screens are formed by means of series of adjacent passage elements that preferably are aligned.

In case at least some of the passage elements are connected to a suction line the method according to the invention can simply be deployed in the withdrawal of fluid from a soil body.

In case at least some of the passage elements are connected to a pressure line the method according to the invention can simply be deployed in the introduction of fluid into a soil body.

In a first possible use, passage elements connected to pressure lines and passage elements connected to suction lines are placed in an alternating way and are connected to respective pressure and suction pumps. The soil can thus easily be treated, for instance by introducing and withdrawing a fluid. The passage elements may here form suction screens and/or pressure screens in groups.

In a further possible use thereof, liquid, particularly water, is introduced into the soil body by means of passage elements connected to the pressure lines and the liquid, while taking along substances, particularly pollutions or usable substances, present in the soil body, is withdrawn via the passage elements connected to the suction lines. In this way a soil layer can be rinsed/washed out. This method may for instance be used when the soil body contains undesirable (in case of a landfill) and/or useful substances (such as in case of exploitation of minerals, such as gold). The latter can for instance be the case in a depot of mineral containing slurry resulting from mining activities. Then water can be withdrawn from the depot, after which the minerals present in the water can be separated from the water.

In a further possible use, particularly on a landfill, (undesirable) gases may be withdrawn by means of passage elements connected to a suction line, possibly for a longer period of time.

In a further possible use, an agent influencing a property of the soil in the soil body is introduced into the soil body via the passage elements, the agent for instance being a bearing capacity enhancing mixture.

In another possible use liquid, particularly water, is withdrawn from the soil body via the passage elements, for instance in view of its consolidation, when the soil body comprises a compressible layer, particularly a clay-containing layer, into which the passage elements extend. The effectiveness is increased when the passage elements at the highest (considered from below) extend to near the lower boundary of the compressible layer.

For creating a vacuum regime in the layer to be treated it is preferred that if the compressible layer is covered by a permeable top layer, the connection of the passage elements and the suction line is laid below the transition to the top layer.

In a use of the method according to the invention the soil body is part of a water bed. A high vacuum in the system can then be achieved when the pump is placed under water, preferably on the water bed.

In another use the upper side of the soil body is situated at ground level, that means on land.

In an embodiment particularly suitable for introducing substances into the soil body the passage elements are tubular, particularly formed by drainage pipes.

Alternatively the passage elements may be formed by drainage strips/drainage ribbons.

From another aspect the invention provides an assembly for withdrawing or introducing substances from or into a soil body, comprising a series of passage elements that are vertical or at an angle and have been introduced into the soil body, which passage elements are fluid intaking or fluid discharging over a substantial part of their length, each vertical passage element having its own suction line or pressure line for fluid connected to its top end, and a pump to which the suction lines or pressure lines have been connected, which pump is connected to a discharge or source for the fluid.

Preferably the suction lines and/or pressure lines are flexible.

In between the pressure lines or suction lines and the pump(s), the assembly can be provided with one or more collection lines that connect to the pump and preferably are flexible.

According to an alternative aspect the application provides a method according to the invention as described above, wherein the passage elements are directly connected with their upper ends to an accompanying collection line leading to a pump or coming from a pump instead of being connected to an own suction or pressure line.

The invention furthermore provides an assembly suitable and intended for carrying out a method according to the invention.

The invention will be elucidated on the basis of exemplary embodiments shown in the drawings, in which:

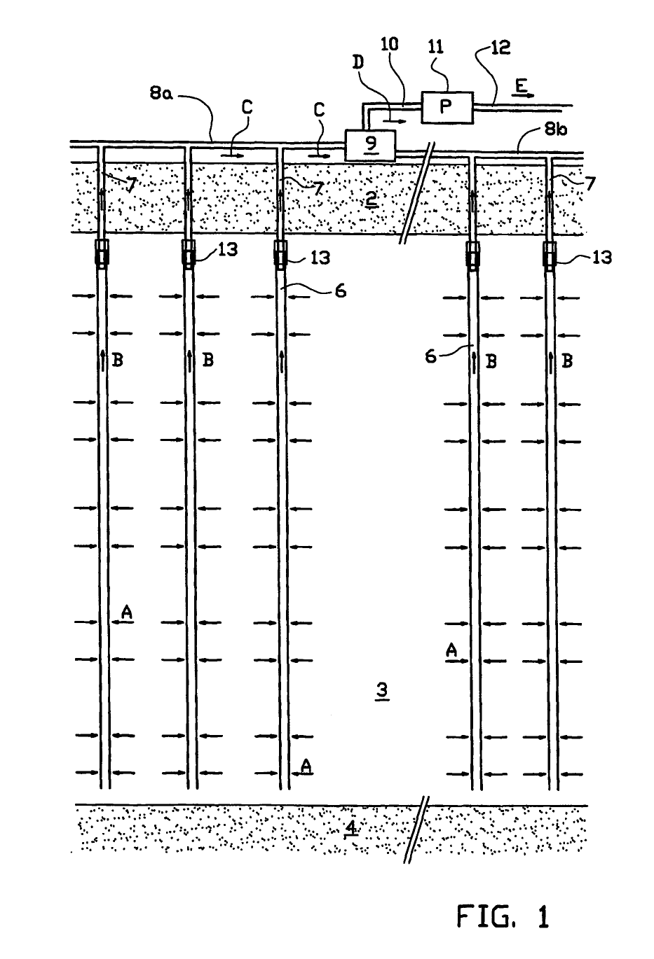

FIG. 1 shows a schematic view of a possible arrangement for a first embodiment of a method according to the invention;

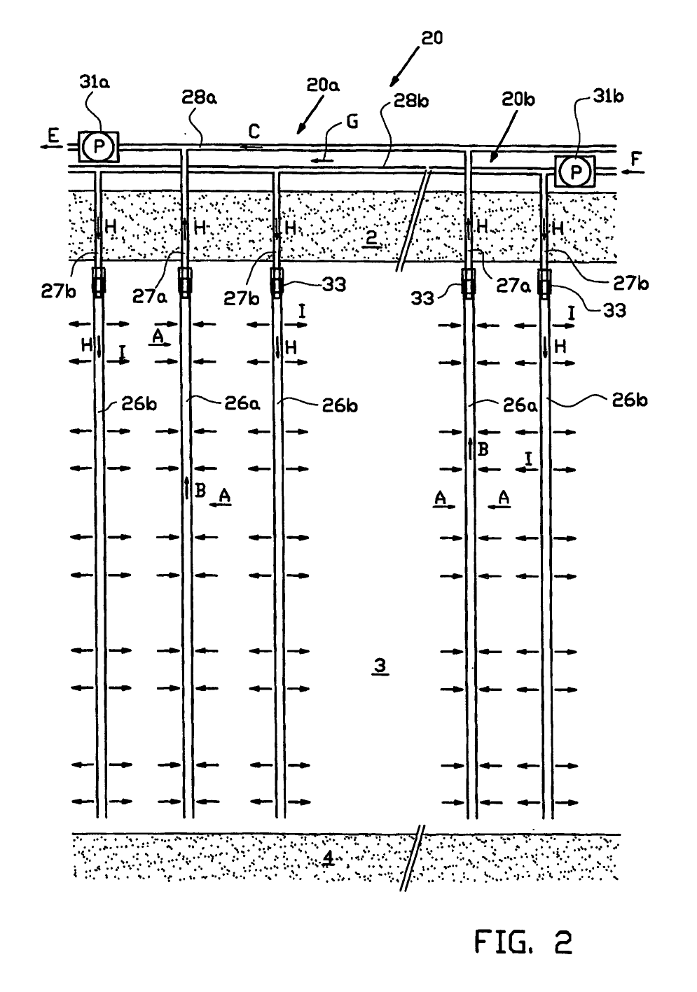

FIG. 2 shows a possible arrangement for a second embodiment of a method according to the invention;

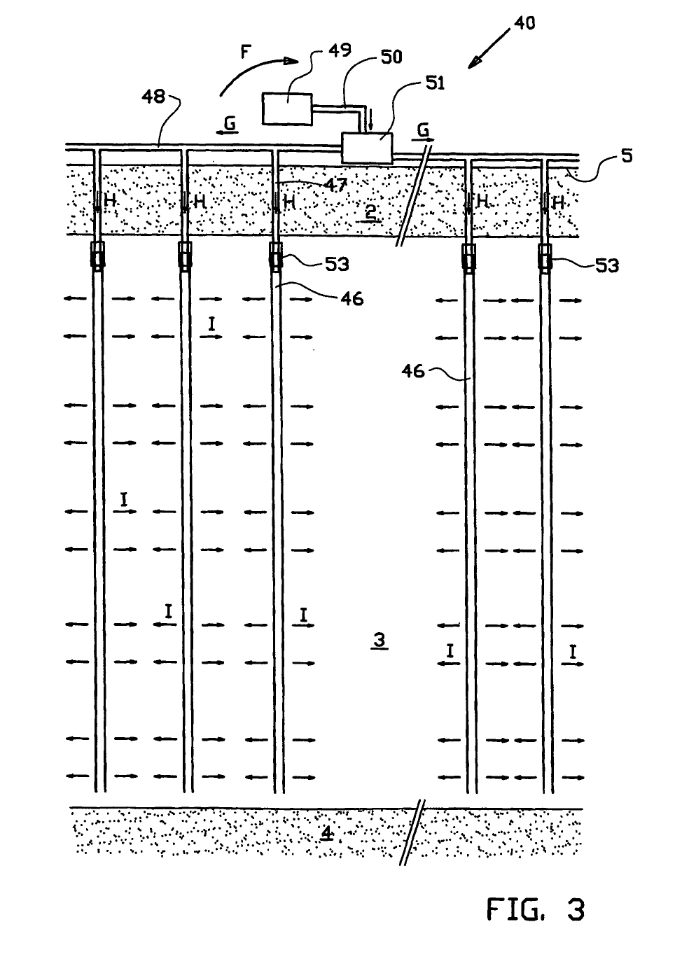

FIG. 3 shows a possible arrangement for a third embodiment of a method according to the invention; and

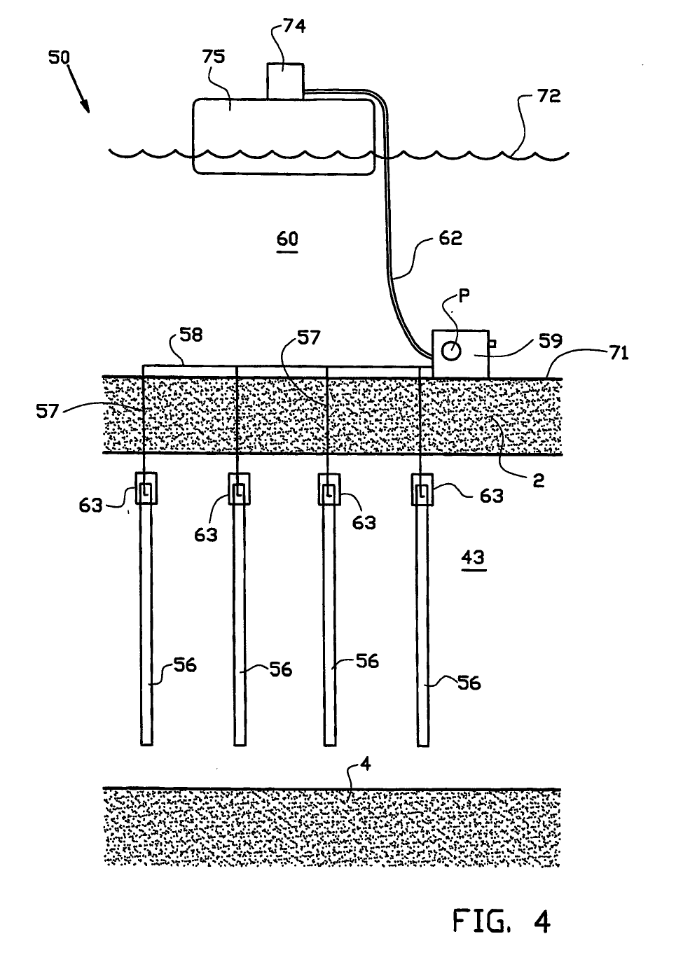

FIG. 4 shows a possible arrangement for a fourth embodiment of a method according to the invention.

In FIG. 1 the numbers 2, 3, 4 and 5 show a soil body, having in this example a deep layer 4 of for instance sand, a top layer 2, for instance of sand as well, having ground level 5, and a layer 3 of for instance clay and/or peat between the sand layers 2 and 4.

In FIG. 1 a series of—preferably flexible—elongated drainage elements 6 has been introduced into the layer 3 to be treated. The drainage elements 6 which in this example are oriented vertically or at a small angle to the vertical, may be pipe-shaped or tubular, such as common drainage pipes, which are provided with passages (perforations) for fluid over their entire length. The drainage elements 6 may also be formed by drainage ribbons known per se.

At their top ends, in this example just below the separation between the layers 2 and 3, the drainage elements 6 are coupled airtight to passage pipes 7 by means of a coupling 13, which passage pipes merge into or connect to a collection line 8a or 8b situated above ground level 5. The collection lines 8a, 8b are flexible and connected to a collection chamber 9, which is connected to a pump 11, having exit 12, via line 10.

The pipes 7 may be flexible, and if necessary extend to below the coupling 13, possibly down into the lower area of the drainage elements 6. Pipes 7 and lines 8 are airtight/watertight in circumference.

The arrangement 1 of FIG. 1 is intended for consolidating the soil by withdrawing water from the clay/peat layer 3. Due to the position of the airtight coupling 13 and because the vertical drainage elements 6 are situated entirely within the compressible and more or less airtight layer 3, air will not or hardly be taken along from other layers or from the atmosphere when withdrawing water from the layer 3. Due to the protection from entry of “false” air a vacuum regime along the drainage elements 6 and in the layer 3 can be set by means of the pump 11.

When the pump 11 becomes operational a vacuum is generated in the drainage elements 6, and water will flow in the direction A, in order to then flow upwards in the drainage elements 6 in the direction B, via the pipes 7, the collection lines 8a, 8b in the direction C, until inside the collection chamber 9, and then in direction D via the line 10, through pump 11, be discharged in the direction E, to a discharge point.

In the arrangement 1 of FIG. 1 the drainage elements 6 can be positioned at randomly selected locations. They can be placed in all kinds of series, or be randomly placed (yet selected indeed). Due to the flexible pipes 7 and flexible collection lines 8a, 8b, there is great freedom in that choice.

In the depiction of FIG. 2 the arrangement 20 has been built up from elements comparable to the ones in the arrangement 1 of FIG. 1, yet in this case there is question of two part-arrangements 20a, 20b.

The part-arrangement 20a, 20b comprise vertical passage elements 26a, 26b, respectively, which via couplings 33, corresponding with couplings 13, are connected to passage pipes 27a, 27b, which merge into or are connected to flexible collection lines 28a, 28b, which are connected to pumps 31a, 31b. The passage elements 26a, 26b may be identical, but are used in opposite direction. They may be identical to the drainage elements 6.

With this arrangement 20 fluid can be supplied to the layer 3 via part-arrangement 20b and can be removed therefrom via part-arrangement 20a. The intention is not consolidation but removal of liquids or gases from the layer 3.

This means for instance gases or liquids taken in in layer 3 when they are partially or entirely the result of the landfill at that location. A treatment substance can also be introduced for treating and subsequently withdrawing a pollution.

By means of pump 31b by a rinse liquid is supplied in the direction F and pressed on in the direction G via central lines 28b, and from there discharged to passage pipes 27b, in order to finally flow in the direction H in passage elements 26b. The liquid exits in the direction I through the passage elements 26b.

As can be seen in FIG. 2 the passage elements 26a, 26b are placed in an alternating way, that means that between (supply) passage elements 26b, which in this case therefore operate oppositely, drainage elements 26a that are used in the usual way, have been placed. The drainage elements 26a are connected to pump 31a via couplings 33, flexible passage pipes 27a and collection line 28a. The liquid in layer 3 will flow in in the direction A in the drainage elements 26a, be sucked in upward in the direction B, and be sucked in via the lines 27a, 27b in direction C by a pump 31a, possibly with interposition of a collection chamber when there is question of several collection lines 28a connected thereto. Discharge then takes place in the direction E, for instance to an installation for treating the extracted liquid.

Rinsing the layers 3 takes place by the liquid that flows through the layer 3 in the directions I and A, from the one passage element 26b to the other passage element 26a. During said flowing the substances/gases can be taken in or taken along with the liquid, and at discharge of the liquid via the drainage elements 26a be extracted from the layer 3.

In FIG. 3 an arrangement 40 is shown, which can be compared to the one of FIG. 1, but which works reversely. The passage elements 46 may correspond with the drainage elements 6 or 26b, and are connected to a pump 51, which is connected this time via a supply line 50 to a collection tray 49. In the collection tray 49 a liquid agent (F) can be placed, which is sucked in by the pump 51 via the line 50 and is discharged to line 48 (direction G), subsequently to flexible passage pipes 47, and then (direction H) to vertical drainage elements 46 in order to flow out in direction I. The drainage elements 46 are here used again in reverse direction.

This example regards the taking in of a liquid in the layer 3, for treating said layer 3, by adding an agent to it, such as for instance a soil stabilising agent for improving the bearing capacity of the layer 3. This may for instance take place by using a cement-water mixture. After the cement has been taken in by the layer 3 and has hardened, the bearing capacity of the layer 3 will have been improved.

In FIG. 4 an arrangement 50 is shown, which differs from the arrangement of the preceding figures in that the passage elements 56 are now accommodated in a layer 43 that is situated in soil body that is part of a water bed. Here as well there is question of a deep layer 4 and a top layer 2, for instance of sand. In this case the upper side of the layer 2 is formed by the water bed surface 71. Furthermore water level 72 of the water body 60 is shown.

At the top end of the flexible drainage elements 56 they are coupled, just within the layer 43, by means of couplings 63 to lower ends of flexible suction lines or pressure lines 57, which extend through the top layer 2 and on the water bed surface 71 are connected to flexible collection line 58. The flexible collection line 58 leads to a collection tray 59 in which a pump P has been placed. The pump with tray 59 have been placed on the water bed surface 71. For being driven the pump is connected by means of supply line 62 to a generating set 74 on a pontoon 75. In the vicinity of shores or banks, the generating set 74 may also be placed on the shore or bank.

Due to the pump being placed on the water bed the vacuum in the system can be increased considerably, due to which the settlement of the soil layer 43, which may for instance be of clay or peat, can be speeded up considerably.

In all arrangements of FIGS. 1-4 there is great freedom in the choice of the location of the drainage or passage elements. By way of example the elements 6, 26, 46, 56 may placed in series transverse to the plane of the drawing.

The drainage elements are vertical in these examples, by they may also be positioned inclined with respect to the vertical.

It is observed that the method according to the invention can also be used when there is no permeable upper layer, in which case the couplings 13, etcetera, are situated just below the surface of the soil body to be treated.

In case of forced consolidation the top layer of the soil body to be treated will have to be more or less gastight/watertight. Usually this is one of the properties of this soil type. Alternatively arranging a sealing layer, for instance of clay, may be opted for. A foil/film may also be used.

In case of forced consolidation a vacuum may also be realised by letting the discharge capacity of the pumps be larger than the supply capacity of the layer above it.

In case of carrying out the method in a soil body under water, the pressure lines and/or suction lines and the collection lines may be situated on the water bed, be suspended in the water column, float on it or be supported otherwise.

For enhancement of the vacuums to be realised it may be opted for to place the (suction) pump below ground level or the water bed surface in the soil body.

After the system has been placed in the soil body, it is also possible to arrange elevations so that the connection lines and collection lines can be confined and may or may not be a permanent part of the elevation. The system is then able to continue operating for a long time.

1-32. (canceled)

33. Method for withdrawing or introducing substances from or into a soil body, wherein a series of, preferably flexible, passage elements that are vertical or at an angle, are introduced into the soil body, which passage elements are fluid intaking or fluid discharging over a substantial part of their length, wherein the passage elements each at their top end are connected to their own watertight and/or gastight suction line or pressure line for fluid, and the suction lines or pressure lines are connected to a pump, which pump is connected to a discharge or source for the fluid, after which by operation of the pump fluid is withdrawn from or supplied to the soil body, via the suction line and/or pressure line and the passage elements, wherein the passage elements are connected to their accompanying suction line by means of a coupling which is situated in the soil body.

34. Method according to claim 33, wherein the suction lines or pressure lines in their turn are connected to one or more collection lines that connect to the pump.

35. Method according to claim 33, wherein passage screens are formed by means of series of adjacent passage elements that are aligned.

36. Method according to claim 33, wherein at least some of the passage elements are connected to a suction line.

37. Method according to claim 33, wherein at least some of the passage elements are connected to a pressure line.

38. Method according to claim 33, wherein at least some of the passage elements are connected to a suction line and wherein at least some of the passage elements are connected to a pressure line, wherein passage elements connected to the pressure lines and passage elements connected to suction lines are placed in an alternating way and are connected to respective pressure and suction pumps.

39. Method according to claim 38, wherein passage screens are formed by means of series of adjacent passage elements that are aligned wherein the passage elements form suction screens and/or pressure screens in groups.

40. Method according to claim 38, wherein by means of passage elements connected to the pressure lines a liquid, particularly water is introduced into the soil body and the liquid, while taking along substances present in the soil body, is withdrawn via the passage elements connected to the suction lines.

41. Method according to claim 33, wherein the coupling is watertight and/or gastight.

42. Method according to claim 41, wherein the substances taken along are pollutions.

43. Method according to claim 42, wherein the substances taken along are usable substances.

44. Method according to claim 33, wherein gases are withdrawn from the soil body.

45. Method according to claim 33, wherein the soil body is formed by a landfill.

46. Method according to claim 37, wherein an agent influencing a property of the matter (such as soil) in the soil body is introduced into the soil body via the passage elements, the agent for instance being a bearing capacity enhancing mixture.

47. Method according to claim 36, wherein liquid, particularly water, is withdrawn from the soil body via the passage elements.

48. Method according to claim 39, wherein the soil body comprises a compressible layer, for instance a clay-containing layer, into which the passage elements extend, wherein liquid, particularly water, is withdrawn from the soil body via the passage elements.

49. Method according to claim 48, wherein the passage elements at the highest extend to the lower boundary of the layer to be treated or the compressible layer.

50. Method according to claim 48, wherein the layer to be treated or the compressible layer is covered by a top layer, wherein the connection of the passage elements and the suction line is laid below the transition to the top layer.

51. Method according to claim 33, wherein the soil body is below a water body.

52. Method according to claim 51, wherein the pump is placed under water, preferably on the water bottom surface.

53. Method according to claim 33, wherein the upper side of the soil body is situated at ground level.

54. Method according to claim 33, wherein the pressure lines and/or suction lines and/or the collection lines are flexible.

55. Method according to claim 33, wherein the passage elements are tubular, particularly formed by drainage pipes.

56. Method according to claim 33, wherein the passage elements are formed by drainage strips/drainage ribbons.

57. Assembly for withdrawing or introducing substances from or into a soil body, comprising a series of passage elements that are vertical or at an angle and have been introduced into the soil body, which passage elements are fluid intaking or fluid discharging over a substantial part of their length, each vertical passage element having its own suction line or pressure line for fluid connected to its top end, and a pump to which the suction lines or pressure lines have been connected, which pump is connected to a discharge or source for the fluid, wherein the passage elements are connected to their accompanying suction line by means of a coupling which is situated in the soil body.

58. Assembly according to claim 57, wherein the suction lines and/or pressure lines in their turn are connected to one or more collection lines that connect to the pump.

59. Assembly according to claim 57, wherein the pressure lines and/or suction lines and/or the collection lines are flexible.
